(19) United States
(12) Patent Application Publication
(10) Pub. No.: US 2009/0156298 A1
(43) Pub. Date: Jun. 18, 2009

(54) METHOD OF DETERMINING A BET AMOUNT AND A GAMING SYSTEM

(75) Inventor: Nick Graham Roach, Wentworth Falls (AU)

Correspondence Address: HANLEY, FLIGHT & ZIMMERMAN, LLC, 150 S. WACKER DRIVE, SUITE 2100, CHICAGO, IL, 60606, US

(73) Assignee: ARISTOCRAT TECHNOLOGIES AUSTRALIA PTY LIMITED, Lane Cove (AU)

(21) Appl. No.: 12/176,875

(22) Filed: Jul. 21, 2008

(30) Foreign Application Priority Data
Jul. 27, 2007 (AU) 2007904053

(51) Int. Cl. G06F 17/00

(52) U.S. Cl. 463/25

(57) ABSTRACT

Systems and methods for determining a bet amount in a gaming system comprises determining a number of play combinations to be played by a player, receiving a total bet amount from the player, and determining a bet per play combination amount from the determined number of play combinations and the received total bet amount.

### CROSS REFERENCE TO RELATED APPLICATIONS

This application is related to and claims the benefit of priority to Australian Provisional Patent Serial No. 2007904053, entitled “A Method Determining a Bet Amount and Gaming System”, filed Jul. 27, 2007, the content of which is herein incorporated by reference in its entirety.

### FIELD

The present invention relates to a method of determining a bet amount in a gaming system, a method of gaming, and a gaming system.

### BACKGROUND

In most modern slot machines, in order to place a bet, a player selects the number of play lines they wish to play and the amount of credits they wish to wager per play line.

The inventors have realised that some players who like to play a particular number of play lines may be restricted in the bets that they will place per pay line because of the size of the resultant total bet per game. Accordingly, the invention proposes an alternative technique for placing the bets.

### SUMMARY OF THE INVENTION

In a first aspect, the invention provides a method of determining a bet amount in a gaming system comprising:
determining a number of play combinations to be played by a player;
receiving a total bet amount from the player; and
determining a bet per play combination amount from the determined number of play combinations and the received total bet amount.

In an embodiment, the method comprises determining the bet per play combination amount to be the credit value for the game.

In an embodiment, the bet per play combination amount is a fraction of a denomination of currency.

In an embodiment, the credit value is not a denomination of currency.

In an embodiment, the method comprises permitting the credit value to be 4 cents.

In an embodiment the play combinations are play lines and determining a number of play combinations comprises receiving a selection of a number of play lines

In an embodiment, determining a number of play combinations comprises receiving a selection of reels from the player and deriving the number of play combinations from the selected reels.

In a second aspect, the invention provides a method of gaming comprising:
determining a number of play combinations to be played by a player;
receiving a total bet amount from the player; and
determining a bet per play combination amount from the determined number of play combinations and the received total bet amount; and
determining any prize award amounts based on the bet per play combination amount.

In an embodiment, the method comprises determining the bet per play combination amount to be the credit value for the game.

In an embodiment, the bet per play line combination is a fraction of a denomination of currency.

In an embodiment, the credit value is not a denomination of currency.

In an embodiment, the method comprises permitting the credit value to be 4 cents.

In an embodiment, the play combinations are play lines and determining a number of play combinations comprises receiving a selection of a number of play lines from the player.

In an embodiment, determining a number of play combinations comprises receiving a selection of reels from the player and deriving the number of play combinations from the selected reels.

In a third aspect, the invention provides a method of gaming comprising:
receiving an instruction to play 25 play lines from a player;
receiving a total bet amount being a multiple (N) of $1.00 from the player, where N is a positive integer in the range 1 to the value of a maximum available total bet;
deeming the credit amount to be $0.04 per play line;
determining a bet per play line amount from the total bet amount and the credit amount; and
determining any prize award amounts based on the bet per play line amount.

In a fourth aspect, the invention provides a gaming system comprising:
a game play mechanism operable by a player to enter a total bet amount and make a selection from which a number of play combinations can be determined; and
a game controller arranged to determine a bet per play combination amount from the number of play combinations and the total bet amount.

In an embodiment, the game controller further arranged to determine any prize award amounts based on the bet per play combination amount.

In an embodiment, the game controller comprises a bet per play combination module arranged to determine the bet per play combination amount.

In an embodiment, the game controller sets the bet per play combination amount to be the credit value for the game.

In an embodiment, the bet per play combination amount is a fraction of a denomination of currency.

In an embodiment, the credit value is not a denomination of currency.

In an embodiment, the game controller is arranged to permit the credit value to be 4 cents.

In an embodiment, the game play mechanism enables a player to place a bet by inputting a number of play lines.

In an embodiment, the game play mechanism enables a player to place a bet by inputting a number of reels.

In an embodiment, the game play mechanism comprises a set of physical buttons.

In an embodiment, the game play mechanism comprises a touch screen operable by touching the touch screen.

In a fifth aspect the invention provides computer program code which when executed implements the method of any one of the first to third aspects.

In a sixth aspect, the invention provides a computer readable medium comprising the above computer program code.

In a seventh aspect, the invention provides a data signal comprising the above computer program code.

In an eighth aspect, the invention extends to transmitting the above computer.

### BRIEF DESCRIPTION OF DRAWINGS

Exemplary embodiments of the invention are described in the following drawings in which:

FIG. 1 is a block diagram of the core components of a gaming system.

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a block diagram of further components of a gaming system; and

FIG. 7 is a flowchart of a gaming method of an embodiment.

These and other features, aspects and advantages of the present invention will become better understood when the following detailed description is read with reference to the accompanying drawings in which like characters represent like part throughout the drawings. The embodiments shown in the drawings are presented for purposes of illustration only. It should be understood, however, that the present invention is not limited to the arrangements and instrumentality shown in the attached drawings.

### DETAILED DESCRIPTION

Referring to the drawings, there is shown a gaming system arranged to implement a game to determine an amount bet per line from a player entered number of play lines and a player entered total bet amount. In an embodiment, the gaming system allows a player to play 25 win lines while betting multiples of $1.00. The gaming system can take a number of different forms.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

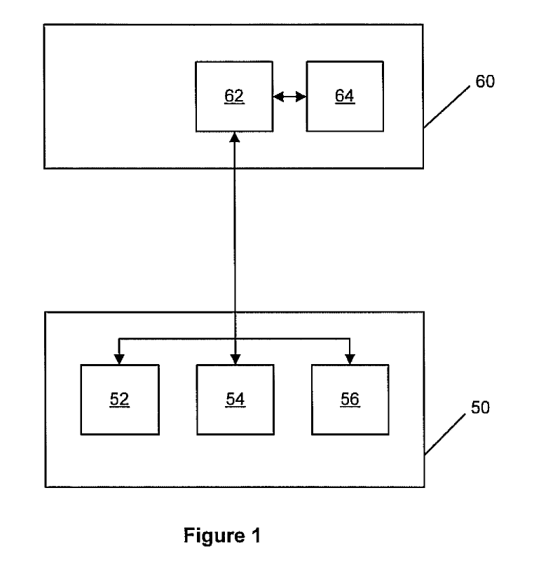

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

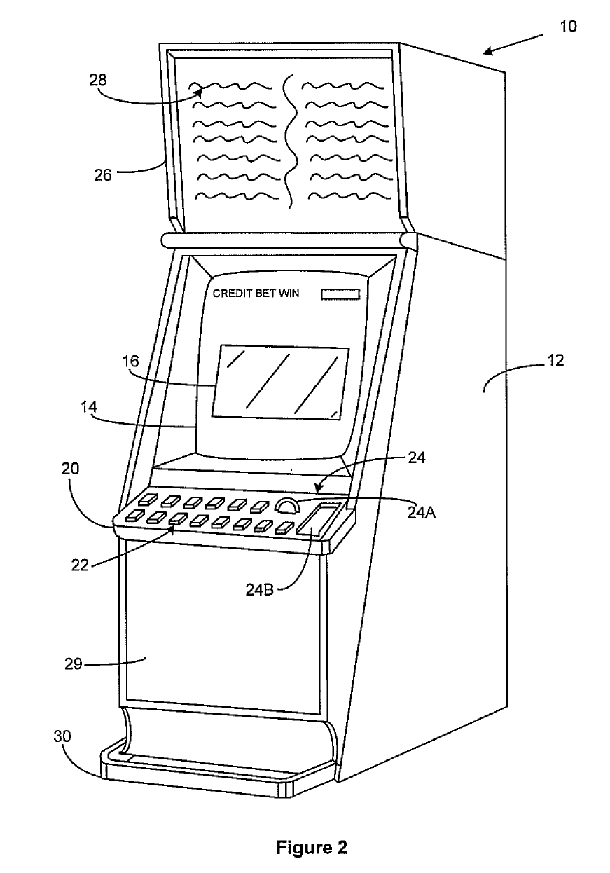

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

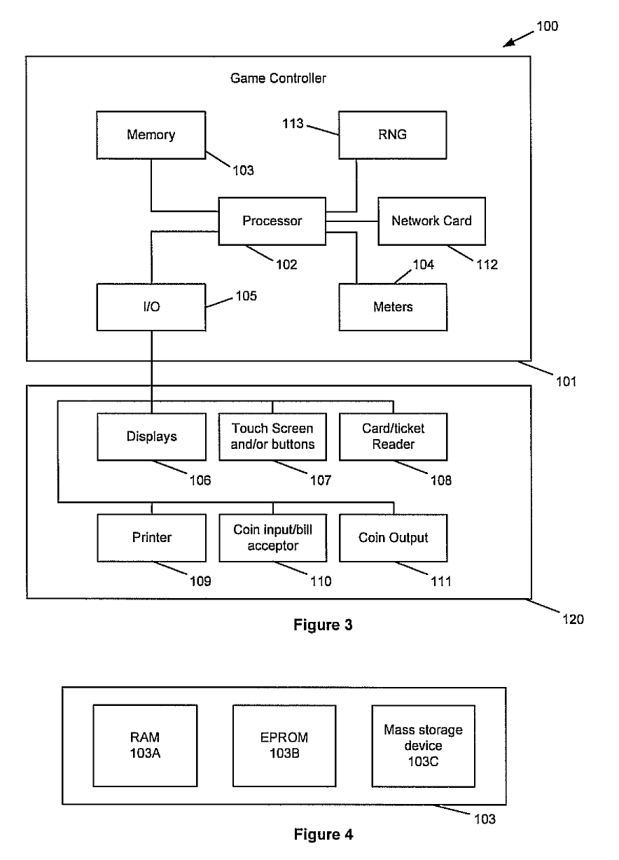

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

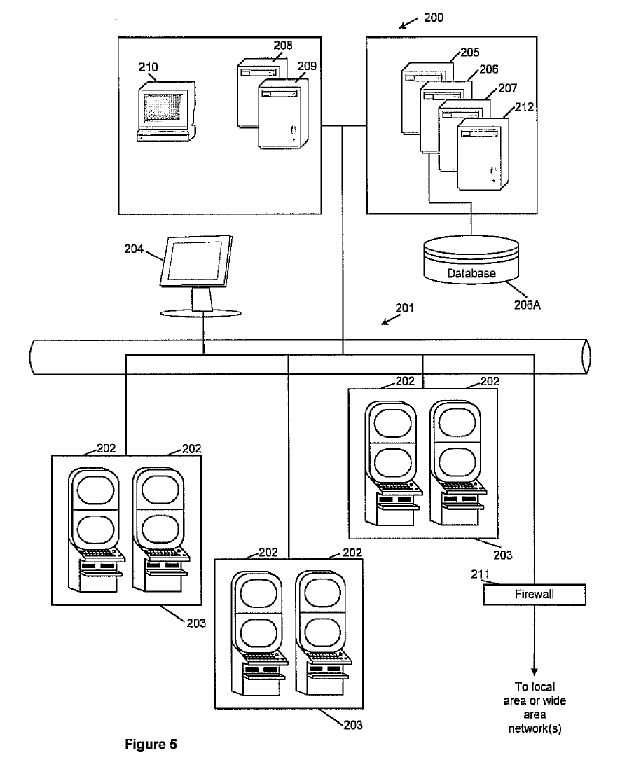

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

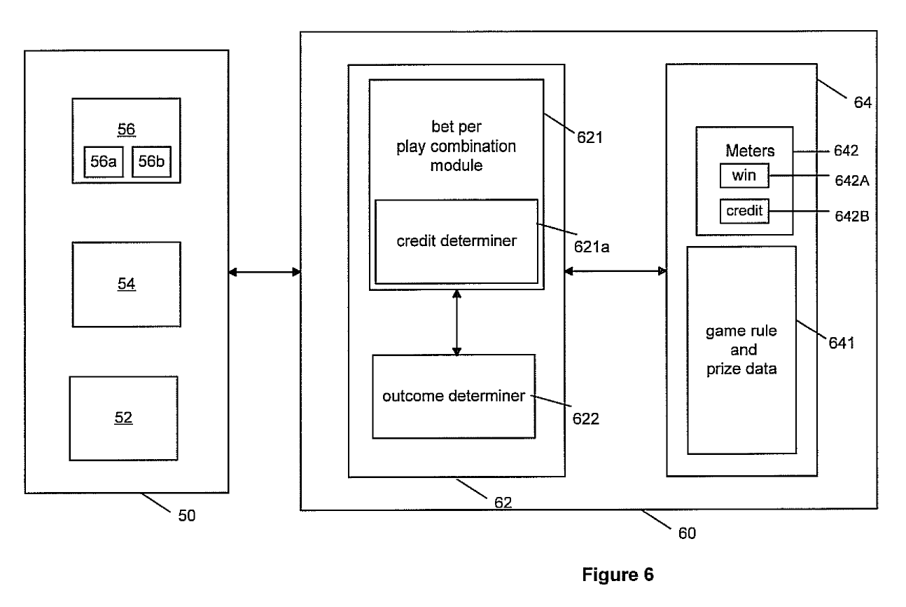

FIG. 6 illustrates the components of a gaming system in accordance with an embodiment.

A person skilled in the art will appreciate that the gaming system will include other components, for example a random number generator to be used by the outcome determiner 622 and a mechanism for selecting the symbols, however details of these features which will be apparent to a person skilled in the art are not included in the block diagram of FIG. 6 for clarity of exposition.

Further, in FIG. 6 various modules are shown as implemented by the processor 62. That is, these are illustrated as software modules embodied in program code stored in memory 64 and executed by the processor 62. A person skilled in the art will appreciate that these functions performed by the modules can be implemented by other apparatus including dedicated hardware.

Referring now to FIG. 6, there is shown in FIG. 6 a game play mechanism 56 which includes a total bet amount selector 56a and a play combination selector 56b. The player can operate the total bet amount selector 56a and the play combination selector 56b to select the total amount they wish to bet and the number of play combinations they wish to play in a game. A person skilled in the art will appreciate that some restrictions, may be placed on the available player selections, for example a minimum total bet amount. In one embodiment, the game play mechanism 56 only allows a player to enter a total bet amount and the desired number of play combinations. In other embodiments, the player also has access to conventional bet placing techniques—e.g. betting an amount of credit per play line. The game play mechanism 56 may be provided by physical buttons or virtual buttons operable by a touch screen.

Once the player enters these amounts, the bet per play combination module 621 determines how much is being bet per play combination by dividing the total bet amount by the number of play combination. In some embodiments, this may require the bet per play combination module 621 to determine a credit value per combination and accordingly in such embodiments the bet per play combination module 621 includes a credit determiner 621a arranged to determine the credit amount per line. For example, the game rule and prize data 641 employed by the outcome determiner 622 may need to know the value of a credit in the game and how many credits are being bet per combination in order to evaluate game outcomes.

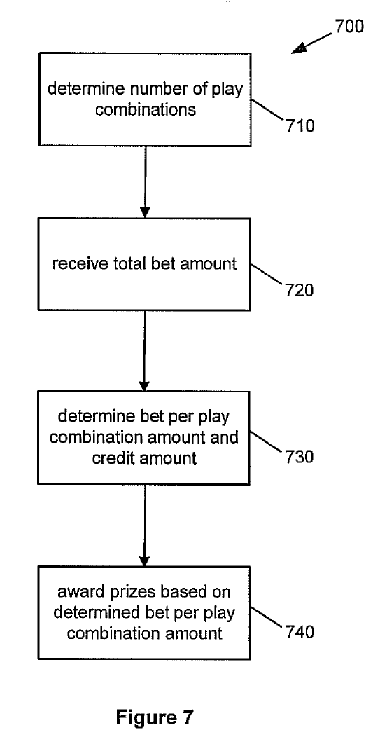

The method 700 is summarised in FIG. 7 and involves receiving a number of play combination from a player 710, receiving a total bet amount 720, determining a bet per play combination amount 730, and optionally a credit amount, and awarding prizes based on the determined bet per play combination amount 740.

Persons skilled in the art will also appreciate that the methods of the embodiments could be embodied in program code. The program code could be supplied in a number of ways, for example on a computer readable medium, such as a disc or a memory (for example, that could replace part of memory 103) or as a data signal (for example, by downloading it from a server).

A person skilled in the art will appreciate in some embodiments the bet per play combination amount may be represented as a credit value per play combination and a number of credits per combination. That is by two parameters rather than a single parameter representing the bet per play combination amount.

An advantage of certain embodiments is to allow the bet per play combination amount to take a value which is not a denomination of currency as well as allowing the bet per play combination amount to be a fraction of denomination of currency. In a typical embodiment, there may be some limitation on the fraction, for example it may only be calculated to two decimal places or three decimal places depending on the specific embodiment. To this end, meters 642 including win meter 642A and credit meter 642B are specially configured to store credit amounts to fractions of the lowest denomination of currency (e.g. 1 cent) or fractions of a credit. This is in contrast to existing meters which only store credits in values down to the lowest denomination of currency. Outcome determiner is similarly specially configured to process fractions of credits. Persons skilled in the art will appreciate that some rounding may be required in order to allow pay outs in currency. Such rounding may be done, for example, when wins are transferred from the win meter 642A to the credit meter 642B or when the credit meter 642B is paid out.

### EXAMPLES

### Example 1

In this example, the bet per play combination module 621 is a bet per play line module and the play combinations are play lines, formed from contiguous symbols from each of the reels. In this example, there are up to a total of 25 different play lines which can be selected by the player. In one particularly advantageous embodiment, the game allows a player to play all 25 play lines of a 25 play line machine while entering bet amounts which are a multiple of $1.00. In this embodiment, in a case where a player plays $1.00 the bet per pay line amount will be $0.04. This allows the credit amount to be deemed to be $0.04 per play line.

An advantage of such an embodiment allows players to place total bet amounts which they feel are responsible, while playing a desired number of play lines. For example, a player may like to bet on all 25 pay lines in order to avail themselves of all possible winning opportunities. However, if a minimum credit amount is $0.05 per game, they may feel that the betting $1.25 per game is irresponsible as it is more than $1.00 a game. Certain embodiments of the present invention allow the player to bet $1.00 a game while playing all 25 win lines.

Various modifications will be apparent to persons skilled in the art. For example, the credit amount may be $0.03, $0.04, $0.06 etc. It will also be apparent that features of the embodiments and examples can be employed to form further embodiments.

### Example 2

In the second example, the gaming system is arranged to implement a Reel Power type game, where the selection of a reel means that each symbol of the reel can be substituted for a symbol at one or more designated display positions. Thus, in this example, the bet per play combination module 621 is arranged to determine the number of play combinations based on the selected reels. In other words, all symbol positions of a selected reel can be used to form symbol combinations with designated, displayed symbol positions of other reels. In this example, there are five reels, each of which can be selected, and each reel has three symbol positions displayed such that after the reels are spun, there are five columns of symbols arranged in three rows. The symbols in the centre row non-selected reels are used to form combinations with each symbol of a selected reel. Thus, by selecting one reel a player gets three pay combinations, by selecting two reels a player gets nine pay combinations, by selecting three reels a player gets 27 pay combination, by selecting four reels a player gets 81 play combinations, and by selecting all five reels a player gets 243 pay combinations.

In the claims which follow and in the preceding description of certain embodiments of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwire or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A method of determining a bet amount in a gaming system comprising:
determining a number of play combinations to be played by a player;
receiving a total bet amount from the player; and
determining a bet per play combination amount from the determined number of play combinations and the received total bet amount.

2. A method as claimed in claim 1, comprising determining the bet per play combination amount to be the credit value for the game.

3. A method as claimed in claim 1, wherein the bet per play combination amount is a fraction of a denomination of currency.

4. A method as claimed in claim 2, wherein the credit value is not a denomination of currency.

5. A method as claimed in claim 4, comprising permitting the credit value to be 4 cents.

6. A method as claimed in claim 1, wherein the play combinations are play lines and determining a number of play combinations comprises receiving a selection of a number of play lines from the player.

7. A method as claimed in claim 1, wherein determining a number of play combinations comprises receiving a selection of reels from the player and deriving the number of play combinations from the selected reels.

8. A method of gaming comprising:
determining a number of play combinations to be played by a player;
receiving a total bet amount from the player; and
determining a bet per play combination amount from the determined number of play combinations and the received total bet amount; and
determining any prize award amounts based on the bet per play combination amount.

9. A method as claimed in claim 8, comprising determining the bet per play combination amount to be the credit value for the game.

10. A method as claimed in claim 8, wherein the bet per play line combination is a fraction of a denomination of currency.

11. A method as claimed in claim 9, wherein the credit value is not a denomination of currency.

12. A method as claimed in claim 11, comprising permitting the credit value to be 4 cents.

13. A method as claimed in claim 8, wherein the play combinations are play lines and determining a number of play combinations comprises receiving a selection of a number of play lines from the player.

14. A method as claimed in claim 8, wherein determining a number of play combinations comprises receiving a selection of reels from the player and deriving the number of play combinations from the selected reels.

15. A method of gaming comprising:
receiving an instruction to play 25 play lines from a player;
receiving a total bet amount being a multiple (N) of $1.00 from the player, where N is a positive integer in the range 1 to the value of a maximum available total bet;
deeming the credit amount to be $0.04 per play line;
determining a bet per play line amount from the total bet amount and the credit amount; and
determining any prize award amounts based on the bet per play line amount.

16. A gaming system comprising:
a game play mechanism operable by a player to enter a total bet amount and make a selection from which a number of play combinations can be determined; and
a game controller arranged to determine a bet per play combination amount from the number of play combinations and the total bet amount.

17. A gaming system as claimed in claim 16, the game controller further arranged to determine any prize award amounts based on the bet per play combination amount.

18. A gaming system as claimed in claim 16, comprising a bet per play combination module arranged to determine the bet per play combination amount.

19. A gaming system as claimed in claim 16, wherein the game controller sets the bet per play combination amount to be the credit value for the game.

20. A gaming system as claimed in claim 19, wherein the bet per play combination amount is a fraction of a denomination of currency.

21. A gaming system as claimed in claim 19, wherein the credit value is not a denomination of currency.

22. A gaming system as claimed in claim 21, wherein the game controller is arranged to permit the credit value to be 4 cents.

23. A gaming system as claimed in claim 16, wherein the game play mechanism enables a player to place a bet by inputting a number of play lines.

24. A gaming system as claimed in claim 16, wherein the game play mechanism enables a player to place a bet by inputting a number of reels.

25. A gaming system as claimed in claim 23, wherein the game play mechanism comprises a set of physical buttons.

26. A gaming system as claimed in claim 23, wherein the game play mechanism comprises a touch screen operable by touching the touch screen.

27. A computer readable medium comprising computer program which when executed implements a method in accordance with claim 1.

28. A computer readable medium comprising computer program which when executed implements a method in accordance with claim 8.

29. A computer readable medium comprising computer program which when executed implements a method in accordance with claim 15.
